(19) United States
(12) Patent Application Publication
(10) Pub. No.: US 2023/0327160 A1
(43) Pub. Date: Oct. 12, 2023

(54) ELECTROLYTE MEMBRANE HAVING EXCELLENT DURABILITY AND PROTON CONDUCTIVITY AND FUEL CELL INCLUDING THE SAME

(71) Applicants: Hyundai Motor Company, Seoul (KR); Kia Corporation, Seoul (KR)

(72) Inventors: In Yu Park, Seoul (KR); Seon Jin Kim, Gimhae (KR)

(21) Appl. No.: 18/063,502

(22) Filed: Dec. 8, 2022

(30) Foreign Application Priority Data
Apr. 11, 2022 (KR) 10-2022-0044438

(51) Int. Cl. H01M 8/1051; H01M 8/1004; H01M 8/1069

(52) U.S. Cl. CPC H01M 8/1051; H01M 8/1004; H01M 8/1069; H01M 2250/20

(57) ABSTRACT

Disclosed are an electrolyte membrane which includes an antioxidant and thus has excellent durability and proton conductivity, and a fuel cell including the same. The antioxidant may include a core including an inorganic particle, and a shell covering at least a portion of a surface of the core and including an ionomer, and the ionomer may include a polymer and a proton conductive functional group bonded to the polymer.

### CROSS-REFERENCE TO RELATED APPLICATION

This application claims under 35 U.S.C. § 119(a) the benefit of priority to Korean Patent Application No. 10-2022-0044438 filed on Apr. 11, 2022, the entire contents of which are incorporated herein by reference.

### TECHNICAL FIELD

The present disclosure relates to an electrolyte membrane having excellent durability and proton conductivity and a fuel cell including the same.

### BACKGROUND

A polymer electrolyte membrane fuel cell for vehicles is a power generation apparatus which produces electricity through electrochemical reactions between hydrogen and oxygen in air. The polymer electrolyte membrane fuel cell has been well known as a next-generation eco-friendly energy source which has high power generation efficiency and does not emit any material other than water. Further, the polymer electrolyte membrane fuel cell may be generally operated at a temperature of equal to or less than 95° C., and can achieve high power density.

The reactions to produce electricity in the fuel cell occurs in a membrane-electrode assembly (MEA) including a perfluorinated sulfonic acid ionomer-based electrolyte membrane, an anode and a cathode. Hydrogen supplied to the anode which is an oxidizing electrode is separated into protons and electrons, the protons migrate to the cathode which is a reducing electrode through the membrane, and the electrons migrate to the cathode through an external circuit. At the cathode, oxygen molecules, the protons and the electrons react together, and thereby electricity and heat are produced and water (H₂O) is simultaneously generated as a reaction by-product.

The electrolyte membrane including a perfluorinated sulfonic acid ionomer (PFSA) has high proton conductivity and exhibits high performance and stability under various humidification conditions, and is thus used most frequently in polymer electrolyte membrane fuel cells. However, the electrolyte membrane including only the perfluorinated sulfonic acid ionomer is thermally degraded at a high temperature of equal to or higher than 100° C., and thus, mechanical properties and dimensional stability thereof are rapidly reduced. Therefore, a fuel cell employing the electrolyte membrane including the perfluorinated sulfonic acid ionomer is generally operated at a temperature of less than 100° C., or at a temperature of equal to or less than 80° C.

When hydrogen and oxygen, which are reaction gases of the fuel cell, react with each other while crossing over the electrolyte membrane, hydrogen peroxide (HOOH) is produced. The hydrogen peroxide generates oxygen-containing radicals, such as hydroxyl radicals (OH) and hydroperoxyl radicals (OOH). These radicals attack the perfluorinated sulfonic acid ionomer, and thus cause chemical degradation of the electrolyte membrane, thereby reducing durability of the fuel cell.

As technology for mitigating chemical degradation of the conventional electrolyte membrane, in the related arts, methods for adding various kinds of antioxidants to electrolyte membranes have been suggested. For example, the antioxidants are divided into primary antioxidants serving as a radical scavenger, secondary antioxidants serving as a hydrogen peroxide decomposer, etc.

The primary antioxidants may include cerium-based antioxidants, such as cerium oxide and cerium (III) nitrate hexahydrate, terephthalic acid-based antioxidants. The secondary antioxidants include manganese-based antioxidants, such as manganese oxide.

An antioxidant, such as cerium (III) nitrate hexahydrate, has been mainly used. For example, cerium ions are bonded to the terminal of a sulfonic acid group of the perfluorinated sulfonic acid ionomer and thus block the migration path of protons (H+), thereby reducing proton conductivity of an electrolyte membrane.

The above information disclosed in this Background section is only for enhancement of understanding of the background of the invention and therefore it may contain information that does not form the prior art that is already known in this country to a person of ordinary skill in the art.

### SUMMARY

In preferred aspects, provided are, inter alia, an antioxidant for a fuel cell, a method for manufacturing the antioxidant, and a fuel cell including the antioxidant. The antioxidant disclosed herein may improve both chemical durability and proton conductivity of a fuel cell.

In one aspect, provided is an antioxidant for fuel cells including a core including an inorganic particle, and a shell covering at least a portion of a surface of the core and including an ionomer. The ionomer may include a polymer and a proton conductive functional group bonded to the polymer.

In certain embodiments, the shell may cover about 10%, about 20%, about 30% about 40%, about 50%, about 60%, about 70%, about 80%, about 90%, about 95%, or about 100% of the surface of the core.

The term “ionomer” as used herein refers to a polymeric material or resin that includes ionized groups attached (e.g., covalently bonded) to the backbone of the polymer as pendant groups. Preferably, such ionized groups may be functionalized to have ionic characteristics, e.g., cationic or anionic.

The ionomer may suitably include one or more polymers selected from the group consisting of a fluoro-based polymer, a perfluorosulfone-based polymer, a benzimidazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, a polyphenylquinoxaline-based polymer and a polystyrene-based polymer.

The inorganic particle may include a compound represented by Chemical Formula 1 below.

MXₐ [Chemical Formula 1]

Herein, M includes at least one selected from the group consisting of cerium (Ce), tin (Sn), zinc (Zn), manganese (Mn), molybdenum (Mo), titanium (Ti) and combinations thereof, X may include at least one of halogen atoms, and a may be the same number as an oxidation number of M.

The polymer may include a main chain and a side chain, the proton conductive functional group may be bonded to the side chain, and the proton conductive functional group may have more proton transfer sites than the side chain.

The polymer may include a perfluorinated sulfonic acid polymer.

The proton conductive functional group may include a phosphoric acid group (—PO₄H₃).

In another aspect, provided is a method for manufacturing an antioxidant for fuel cells including preparing a dispersion solution including an ionomer, and adding a core comprising an inorganic particle to the dispersion solution to form a shell covering at least a portion of a surface of the core. The shell may include the ionomer, and the ionomer may include a polymer and a proton conductive functional group bonded to the polymer.

The preparing the dispersion solution may include preparing an admixture including a precursor of the proton conductive functional group and a solution including the polymer, and stirring the admixture.

The admixture may suitably include about 0.00188 parts by weight to 0.188 parts by weight of the precursor based on 100 parts by weight of the polymer.

The admixture may be stirred at a temperature of about 30° C. to 140° C.

Preferably, an amount of about 10 parts by weight to 1,000 parts by weight of the core may be added to the dispersion solution based on 100 parts by weight of the ionomer.

The method may further include heat-treating a resultant, after forming the shell covering the surface of the core.

The heat-treating may be performed at a temperature of about 100° C. to 200° C.

In another aspect, provided is a fuel cell including an electrolyte membrane including an ion transfer material, a pair of electrodes disposed on both surfaces of the electrolyte membrane, and gas diffusion layers disposed on the pair of the electrodes. In particular, at least one of the electrolyte membrane, the electrodes and the gas diffusion layers includes the above antioxidant.

The electrolyte membrane may suitably include an amount of about 0.1 parts by weight to 20 parts by weight of the antioxidant based on 100 parts by weight of the ion transfer material.

The ion transfer material may have a greater equivalent weight than an equivalent weight of the ionomer.

Also provided is a vehicle including the fuel cell described herein.

Other aspects of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a cross-sectional view of an exemplary membrane-electrode assembly according to an exemplary embodiment of the present disclosure;

FIG. 2 shows an exemplary electrolyte membrane according to an exemplary embodiment of the present disclosure;

FIG. 3 shows an exemplary electrolyte membrane according to an exemplary embodiment of the present disclosure;

FIG. 4 shows an exemplary antioxidant according to an exemplary embodiment of the present disclosure;

FIG. 5 shows chemical durabilities of electrolyte membranes according to Example, Comparative Example 1 and Comparative Example 2; and

FIG. 6 shows proton conductivities of the electrolyte membranes according to Example, Comparative Example 1 and Comparative Example 2.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

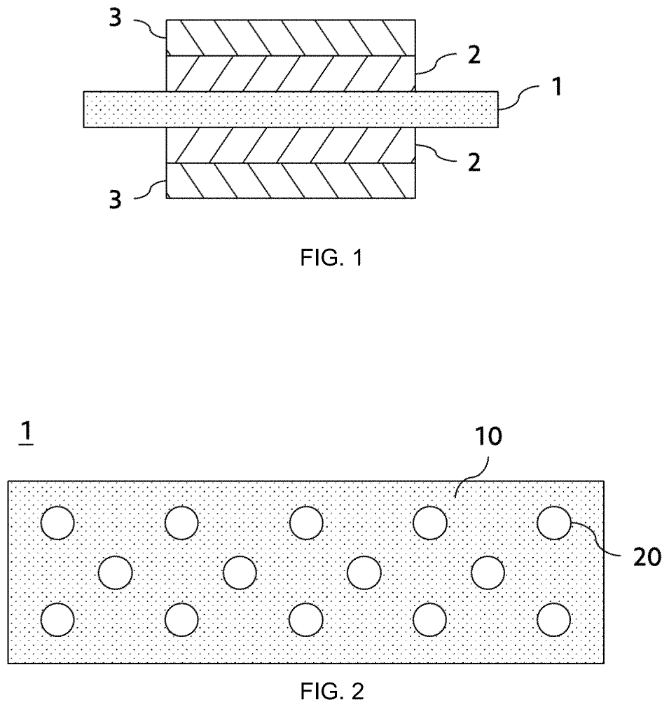

FIG. 1 shows a cross-sectional view of an exemplary membrane-electrode assembly included in a fuel cell according to an exemplary embodiment of the present disclosure. The membrane-electrode assembly may include an electrolyte membrane 1, electrodes 2 disposed on both surfaces of the electrolyte membrane 1, and gas diffusion layers 3 disposed on the electrodes 2.

At least one of the electrolyte membrane 1, the electrodes 2 and the gas diffusion layers 3 may include an antioxidant.

FIG. 2 shows an exemplary electrolyte membrane 1 according to an exemplary embodiment of the present disclosure. The electrolyte membrane 1 may include an ion transfer material 10 and an antioxidant 20.

The ion transfer material 10 may transfer protons in the electrolyte membrane 1.

The ion transfer material 10 may include any material which is commonly used in the field to which the present disclosure belongs. For example, the ion transfer material 10 may include a perfluorinated sulfonic acid polymer.

The antioxidant 20 may be distributed in the ion transfer material 10. A detailed description of the antioxidant 20 will be given later.

The electrolyte membrane 1 may suitably include an amount of about 0.1 to 20 parts by weight of the antioxidant 20 based on 100 parts by weight of the ion transfer material 10. When the content of the antioxidant 20 is less than about 0.1 parts by weight, a degree of improvement in chemical durability of the electrolyte membrane 1 may be insignificant. When the content of the antioxidant 20 is greater than about 20 parts by weight, the content of the ion transfer material 10 may not be sufficient, and thus, proton conductivity of the electrolyte membrane 1 may be reduced.

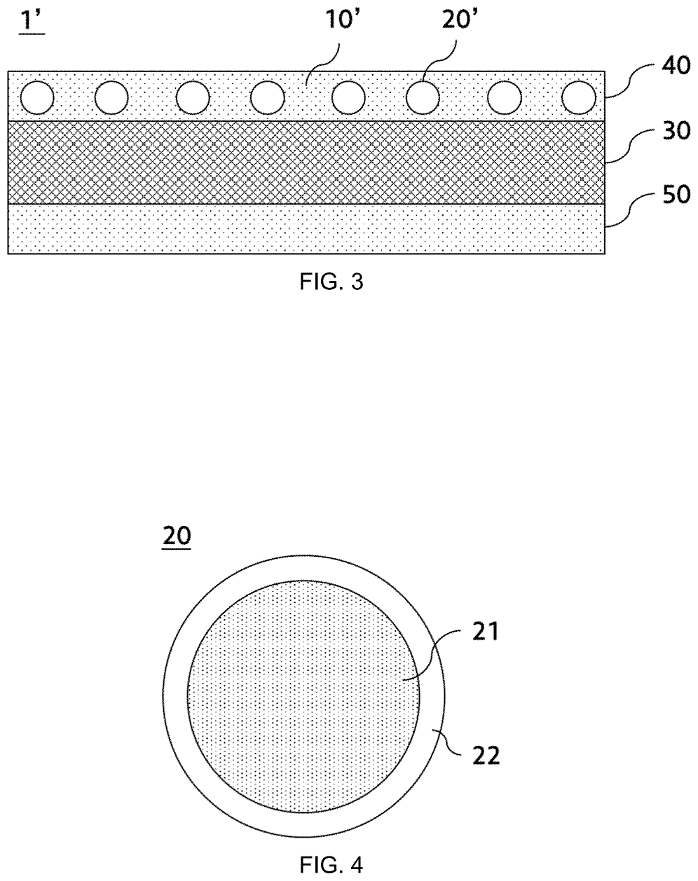

FIG. 3 shows an electrolyte membrane 1′ according to another embodiment of the present invention. The electrolyte membrane 1′ may include a reinforcement layer 30, a first ion transfer layer 40 disposed on one surface of the reinforcement layer 30, and a second ion transfer layer 50 disposed on another surface of the reinforcement layer 30. However, the embodiment of the present disclosure is not limited thereto, and the electrolyte membrane 1′ including only the first ion transfer layer 40 and the electrolyte membrane 1′ including only the second ion transfer layer 50 may be included in this embodiment of the present disclosure.

The reinforcement layer 30 may increase the mechanical properties of the electrolyte membrane 1′.

The reinforcement layer 30 may be porous so that pores in the reinforcement layer 30 are impregnated with an ion transfer material 10′. Therefore, protons may be transferred even in the reinforcement layer 30.

The reinforcement layer 30 may include at least one selected from the group consisting of polytetrafluoroethylene (PTFE), expanded polytetrafluoroethylene (e-PTFE), polyethylene (PE), polypropylene (PP), polyphenylene oxide (PPO), polybenzimidazole (PBI), polyimide (PI), polyvinylidene fluoride (PVDF), polyvinyl chloride (PVC) and combinations thereof.

The first ion transfer layer 40 and the second ion transfer layer 50 may include the ion transfer material 10′. The first ion transfer layer 40 and/or the second ion transfer layer 50 may further include an antioxidant 20′. Although FIG. 3 illustrates the electrolyte member 1′ in which the first ion transfer layer 40 includes the antioxidant 20′, the embodiment of the present disclosure is not limited thereto, and at least one of the reinforcement layer 30, the first ion transfer layer 40 and the second ion transfer layer 50 may include the antioxidant 20′.

FIG. 4 shows an exemplary antioxidant 20 according to an exemplary embodiment of the present disclosure. The antioxidant 20 may include a core 21 including an inorganic particle, and a shell 22 covering a surface of the core 21.

The core 21 may include the inorganic particle including a compound having antioxidant properties and represented by Chemical Formula 1 below.

MXₐ [Chemical Formula 1]

Here, M includes at least one selected from the group consisting of cerium (Ce), tin (Sn), zinc (Zn), manganese (Mn), molybdenum (Mo), titanium (Ti) and combinations thereof.

X may include at least one of halogen atoms.

The a may be a number determined to allow the compound to become neutral in consideration of the oxidation number of M and the oxidation number of X, or the same number as the oxidation number of M. For example, a may be a number within the range of 1 to 6.

The inorganic particle may include cerium fluoride represented by CeF₃ or CeF₄, cerium chloride represented by CeCl₃, manganese fluoride represented by MnF₂, MnF₃ or MnF₄, manganese chloride represented by MnCl₂, tin fluoride represented by SnF₂ or SnF₄, tin chloride represented by SnCl₂ or SnCl₄, molybdenum fluoride represented by MoF₃, MoF₅ or MoF₆, or molybdenum chloride represented by MoCl₂, MoCl₃, MoCl₅ or MoCl₆.

The shell 22 may include an ionomer having proton conductivity.

Particularly, when the inorganic particle having antioxidant properties are applied to the electrolyte membrane 1, chemical durability may increase, and at least a portion, or entire the surface of the inorganic particle may be covered with the ionomer having proton conductivity so as to prevent degradation of proton conductivity of the electrolyte membrane 1 due to applying of the inorganic particle.

Further, in addition to prevention of reduction in proton conductivity of the electrolyte membrane 1, a polymer having proton conductivity, to which a proton conductive functional group is additionally bonded, may be used as the ionomer so as to improve proton conductivity of the electrolyte membrane 1.

The polymer may include a main chain (i.e., a backbone) and a side chain having proton conductivity, and the proton conductive functional group may be bonded to the terminal of the side chain. The proton conductive functional group may have more proton transfer sites than the side chain. The proton transfer sites may be partial structures which protons are electrochemically bonded and/or separated, and the proton conductive functional group may be represented by R—O⁻ based on an ionized state. For example, a sulfonic acid group represented by R—SO₃⁻ has one proton transfer site, and a phosphoric acid group represented by R—PO₃²⁻ has two proton transfer sites.

The polymer may include a perfluorinated sulfonic acid polymer. For example, the polymer may include Nafion.

The proton conductive functional group may include a phosphoric acid group. In consideration of proton conductivity, the proton conductive functional group may preferably be the phosphoric acid group.

For example, the ionomer may have a side chain structure represented by Chemical Formula 2 below.

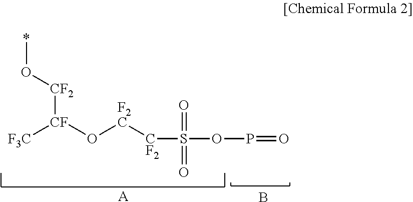

In Chemical Formula 2, * indicates a part bonded to the main chain. A indicates the side chain included in the polymer having proton conductivity, and Chemical Formula 2 represents a structure in which the sulfonic acid group is attached to the terminal of the side chain. B indicates a proton conductive functional group additionally bonded to the polymer, and may preferably include the phosphoric acid group.

The phosphoric acid group has two proton transfer sites due to —O, and the number of the proton transfer sites of the phosphoric acid group is greater than that of the sulfonic acid group or a carboxyl group. Therefore, the phosphoric acid group is substituted for the functional group of the polymer, the number of proton transfer sites is increased, and thus, proton conductivity may be increased.

Further, reduction in the proton conductivity of the electrolyte membrane 1 due to applying of the antioxidant 20 may be offset by increasing the equivalent weight of the ion transfer material 10 compared to the ionomer. The equivalent weight of the ion transfer material 10 may be equal to or less than about 1,500 g/eq, or may be about 500 g/eq to 1,200 g/eq, without being limited to a specific value.

The chemical durability and proton conductivity of the electrolyte membrane 1 may be improved in a balanced way through the substituent of the ionomer forming the shells 22 and the equivalent weight of the ion transfer material 10.

The thickness of the shell 22 is not limited to a specific value and, for example, may be about 1 nm to 1 μm. The shell 22 may be formed to have a thickness sufficient not to degrade antioxidant performance of the cores 21.

A method for manufacturing the antioxidant may include preparing a dispersion solution including the ionomer, and adding a core comprising an inorganic particle to the dispersion solution to form a shell covering a surface of the core, wherein the shell comprises the ionomer.

The dispersion solution may be prepared by producing an admixture including a precursor of the proton conductive functional group and a solution including the polymer and stirring the admixture.

A proper kind of precursor may be suitably selected depending on the desired proton conductive functional group. For example, the precursor may include phosphoric acid or the like.

The admixture may be prepared by adding about 0.00188 parts by weight to 0.188 parts by weight or about 0.0188 parts by weight to 0.0937 parts by weight of the precursor based on 100 parts by weight of the polymer. When the amount of the precursor is less than 0.00188 parts by weight, a degree of improvement in chemical durability of the ionomer may be insignificant, and, when the amount of the precursor is greater than about 0.188 parts by weight, the amount of the proton conductive functional group bonded to the polymer may be excessively increased and may thus cause poisoning of an electrode.

The proton conductive functional group may be bonded to the polymer by stirring the admixture at a temperature of about 30° C. to 140° C., or about 50° C. to 100° C. When the temperature is less than about 30° C., the polymer and the precursor may not react with each other, and, when the temperature is greater than about 140° C., the precursor may be thermally degraded.

The stirring time of the admixture is not limited to a specific value and, for example, may be about 60 minutes.

The surfaces of the core including the inorganic particle may be covered, partially or entirely, with the shell including the ionomer by adding the core to the dispersion solution.

An amount of about 10 parts by weight to 1,000 parts by weight of the core may be added to the admixture, based on the 100 parts by weight of the ionomer. When the amount of the core is greater than 1,000 parts by weight, the amount of the ionomer is insufficient, and the shell may not be properly formed.

The antioxidant may be acquired by stirring and drying the dispersion solution until a liquid component is sufficiently removed from the dispersion solution, after the core have been added to the dispersion solution. Drying of the dispersion solution is not limited to specific conditions, and the dispersion solution may be dried at a temperature for a time sufficient not to degrade the inorganic particles and the ionomer.

The method for manufacturing the antioxidant may further include heat-treating the antioxidant. Such heat treatment may increase crystallinity of the ionomer so as to prevent the shell from separating during a process of manufacturing an electrolyte membrane.

The antioxidant may be heat-treated at a temperature of about 100° C. to 200° C., or about 120° C. to 160° C. When the heat treatment temperature is less than 100° C., crystallinity of the ionomer is not sufficiently increased, and the ionomer may be melted and the shell may be separated during the process of manufacturing the electrolyte membrane using the antioxidant. On the other hand, when the heat treatment temperature is greater than about 200° C., the ionomer may be thermally degraded.

The heat treatment is not limited to a specific time, and may be performed, for example, for about 10 minutes.

A method for manufacturing a membrane-electrode assembly may include preparing a solution including the antioxidant and an ion transfer material, manufacturing an electrolyte membrane by applying the solution to a substrate and drying the solution, forming electrodes on both surfaces of the electrolyte membrane, and forming gas diffusion layers on the electrodes.

The solution may be prepared by adding the ion transfer material and the antioxidant to a solvent, such as distilled water, alcohol or the like.

An amount of about 100 parts by weight of the ion transfer material and an amount of about 0.1 parts by weight to 20 parts by weight of the antioxidant may be added to the solvent.

After the ion transfer material and the antioxidant have been added to the solvent, the solution may be stirred for about 10 minutes to 300 minutes or about 30 minutes to 120 minutes. When the stirring time is less than about 10 minutes, the ion transfer material and the antioxidant may not be uniformly distributed, and, when the stirring time is greater than about 300 minutes, processability may be reduced.

Application of the solution to the substrate and drying of the solution are not limited to a specific method, and may be performed using a method which is commonly used in the field to which the present disclosure belongs.

When the electrolyte membrane incudes a reinforcement layer, the electrolyte membrane may be manufactured by applying the solution to a substrate, stacking the reinforcement layer thereon so that the reinforcement layer may be impregnated with the ion transfer material, and then applying the solution on the reinforcement layer.

The membrane-electrode assembly may be manufactured by adhering the electrodes to both surfaces of the electrolyte membrane and forming the gas diffusion layers on the electrodes. Adhesion of the electrodes and formation of the gas diffusion layers are not limited to a specific method, and may be performed using a method which is commonly used in the field to which the present disclosure belongs.

### Example

Hereinafter, the present disclosure will be described in more detail through the following examples. The following examples serve merely to exemplarily describe the present disclosure, and are not intended to limit the scope of the invention.

### Manufacturing Example—Manufacture of Antioxidant

A mixed solution was prepared by adding 5 g of a polymer dispersion (20% by weight of a solid content) and adding 0.0188 parts by weight of phosphoric acid (PO₄H₃) based on 100 parts by weight of the solid content of the polymer dispersion, to 100 g of a mixed solvent of distilled water and alcohol. A perfluorinated sulfonic acid polymer was used as a polymer. A dispersion including an ionomer was manufactured by stirring the mixed solution at a temperature of 80° C. for 60 minutes.

Cerium fluoride was added to the dispersion as an inorganic particle. 100 parts by weight of cerium fluoride was added based on 100 parts by weight of the ionomer. A resultant was dried at a temperature of about 80° C. while being stirred until a liquid component sufficiently disappears.

The dried resultant was heat-treated in a vacuum oven at a temperature of about 140° C. for about 10 minutes.

### Example

A solution was prepared by adding a perfluorinated sulfonic acid polymer which is an ion transfer material and the antioxidant manufactured according to Manufacturing Example to a mixed solvent of distilled water and alcohol. An electrolyte membrane was manufactured by applying the solution to a substrate.

### Comparative Example 1

An electrolyte membrane was manufactured in the same manner as in Example, except that cerium (III) nitrate hexahydrate was used as an antioxidant.

### Comparative Example 2

An electrolyte membrane was manufactured in the same manner as in Example, except that cerium fluoride was used as an antioxidant. That is, the antioxidant without a shell was used in Comparative Example 2.

### Test Example 1

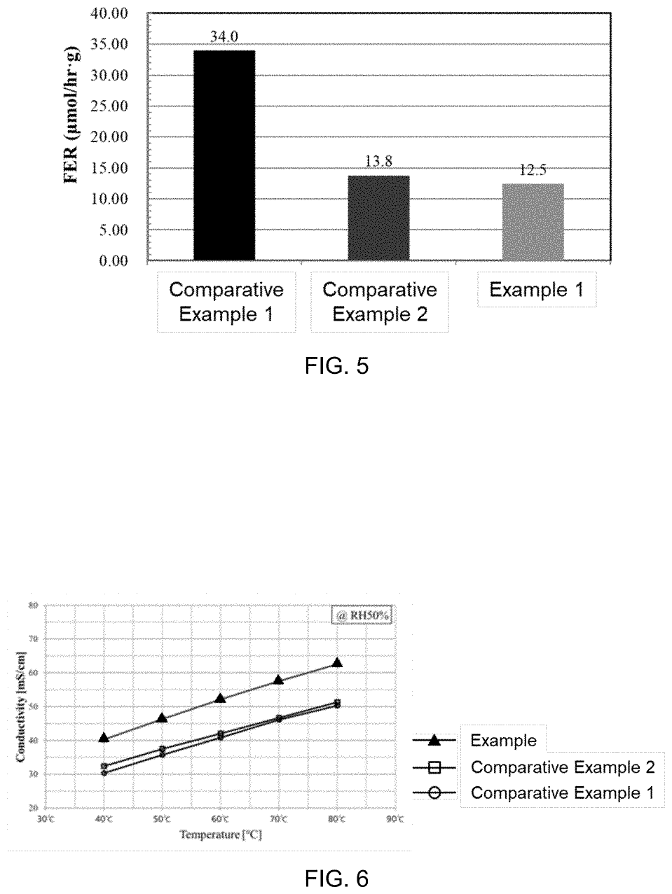

In order to verify chemical durabilities of the electrolyte membranes according to Example, Comparative Example 1 and Comparative Example 2, Fluorine Emission Rates (FERs) of the respective electrolyte membranes were measured in the state in which the respective electrolyte membranes were immersed in Fenton's reagent for 24 hours. When antioxidant properties of an antioxidant are not sufficient, a corresponding electrolyte membrane including the antioxidant is degraded due to radicals generated by reaction between the Fenton's reagent and the electrolyte membrane, and thus emits fluoride ions (F⁻). Therefore, antioxidant properties of the respective electrolyte membranes may be comparatively evaluated by measuring the concentrations of fluoride ions in the Fenton reagent after a designated time has passed. Results are shown in FIG. 5.

As shown in FIG. 5, the FER of the electrolyte membrane according to Example was less than the FERs of the electrolyte membranes according to Comparative Example 1 and Comparative Example 2. It means that the electrolyte membrane according to Example exhibits excellent chemical durability.

### Test Example 2

Proton conductivities of the electrolyte membranes according to Example, Comparative Example 1 and Comparative Example 2 were evaluated. Proton conductivities of the respective electrolyte membranes were evaluated under designated conditions, i.e., at a temperature of 40° C. to 80° C. and a relative humidity of 50%. As shown in FIG. 6, the electrolyte membrane according to Example exhibited much higher proton conductivity than the electrolyte membranes according to Comparative Example 1 and Comparative Example 2.

According to various exemplary embodiments of the present disclosure, an electrolyte membrane having excellent chemical durability and high proton conductivity can be provided. At the same time, the electrolyte membrane may have excellent chemical durability and high proton conductivity.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An antioxidant for fuel cells, comprising:
a core comprising an inorganic particle; and
a shell covering at least a portion of a surface of the core and comprising an ionomer,
wherein the ionomer comprises a polymer and a proton conductive functional group bonded to the polymer.

2. The antioxidant for fuel cells of claim 1, wherein the inorganic particle comprises a compound represented by Chemical Formula 1 below,
MXₐ, wherein: [Chemical Formula 1]
M comprises cerium (Ce), tin (Sn), zinc (Zn), manganese (Mn), molybdenum (Mo), titanium (Ti), or any combination thereof;
X comprises at least one of halogen atoms; and
a is the same number as an oxidation number of M.

3. The antioxidant for fuel cells of claim 1, wherein:
the polymer comprises a main chain and a side chain;
the proton conductive functional group is bonded to the side chain; and
the proton conductive functional group has more proton transfer sites than the side chain.

4. The antioxidant for fuel cells of claim 1, wherein the polymer comprises a perfluorinated sulfonic acid polymer.

5. The antioxidant for fuel cells of claim 1, wherein the proton conductive functional group comprises a phosphoric acid group (—PO₄H₃).

6. A method for manufacturing an antioxidant for fuel cells, comprising:
preparing a dispersion solution comprising an ionomer; and
adding a core comprising an inorganic particle to the dispersion solution to form a shell covering at least a portion of a surface of the core, wherein the shell comprises the ionomer,
wherein the ionomer comprises a polymer and a proton conductive functional group bonded to the polymer.

7. The method of claim 6, wherein the preparing the dispersion solution comprises:
preparing an admixture comprising a precursor of the proton conductive functional group and a solution comprising the polymer; and
stirring the admixture.

8. The method of claim 6, wherein:
the polymer comprises a main chain and a side chain;
the proton conductive functional group is bonded to the side chain; and
the proton conductive functional group has more proton transfer sites than the side chain.

9. The method of claim 6, wherein the polymer comprises a perfluorinated sulfonic acid polymer.

10. The method of claim 6, wherein the proton conductive functional group comprises a phosphoric acid group (—PO₄H₃).

11. The method of claim 7, wherein the admixture comprises about 0.00188 parts by weight and 0.188 parts by weight of the precursor, based on 100 parts by weight of the polymer.

12. The method of claim 7, wherein the admixture is stirred at a temperature of about 30° C. to 140° C.

13. The method of claim 6, wherein the inorganic particle comprises a compound represented by Chemical Formula 1 below,
MXₐ, wherein: [Chemical Formula 1]
M comprises at least one of cerium (Ce), tin (Sn), zinc (Zn), manganese (Mn), molybdenum (Mo), titanium (Ti) or any combination thereof;
X comprises at least one of halogen atoms; and
a is the same number as an oxidation number of M.

14. The method of claim 6, wherein an amount of about 10 parts by weight to 1,000 parts by weight of the core is added to the dispersion solution, based on 100 parts by weight of the ionomer.

15. The method of claim 6, further comprising heat-treating a resultant, after forming the shell covering the surface of the core.

16. The method of claim 15, wherein the heat-treating is performed at a temperature of about 100° C. to 200° C.

17. A fuel cell comprising:
an electrolyte membrane comprising an ion transfer material;
a pair of electrodes disposed on both surfaces of the electrolyte membrane; and
gas diffusion layers disposed on the pair of the electrodes,
wherein at least one of the electrolyte membrane, the electrodes and the gas diffusion layers comprises an antioxidant of claim 1.

18. The fuel cell of claim 17, wherein the electrolyte membrane comprises an amount of about 0.1 parts by weight to 20 parts by weight of the antioxidant based on 100 parts by weight of the ion transfer material.

19. The fuel cell of claim 17, wherein the ion transfer material has a greater equivalent weight than an equivalent weight of the ionomer.

20. A vehicle comprising a fuel cell of claim 17.
